(19) United States
(12) Patent Application Publication
(10) Pub. No.: US 2012/0102154 A1
(43) Pub. Date: Apr. 26, 2012

(54) Cloud-Based Transcoding Platform Systems and Methods

(75) Inventors: Yu Huang, Bridgewater, NJ (US); Xutao Lv, Columbia, MO (US); Yue Chen, San Jose, CA (US); Hong Heather Yu, West Windsor, NJ (US)

(73) Assignee: FutureWei Technologies, Inc., Plano, TX (US)

(21) Appl. No.: 13/277,067

(22) Filed: Oct. 19, 2011

Related U.S. Application Data
(60) Provisional application No. 61/406,726, filed on Oct. 26, 2010.

(51) Int. Cl. G06F 15/16

(52) U.S. Cl. 709/219; 709/217

(57) ABSTRACT

Methods and systems for transcoding in a cloud computing platform are disclosed. According to an embodiment, a receiver receives an uploading file by one data block at a time, and stores the received data blocks in various storage modules. Small segment files are then generated when the size of the received data blocks is larger than a threshold. A transcoder transcodes the small segment files from one format such as a bit rate or a frame size to another while the receiver is still receiving a new data block. The transcoded small segment files may be stitched together to form a stitched file, which may be stored in a storage module to be downloaded through a content distribution network (CDN). The transcoded small segment files may be passed to streaming servers for streaming over a network while the receiver is still receiving a new data block of the uploading file.

This application claims the benefit of U.S. Provisional Application Ser. No. 61/406,726, filed on Oct. 26, 2010, entitled “Cloud-Based Transcoding Platform,” which application is hereby incorporated herein by reference.

### TECHNICAL FIELD

The present invention relates to signal processing systems and methods, in particular embodiments, to a cloud based transcoding platform systems and methods.

### BACKGROUND

Software platforms are moving from their traditional centricity around individually owned and managed computing resources up into the “cloud” of the Internet. Cloud computing is network-based computing, e.g., Internet-based computing. Shared resources, software, and information are provided to computers and other devices on demand, like the electricity grid. Cloud computing is a paradigm shift following the shift from mainframe to client-server in the early 1980s. Typical cloud computing providers deliver common business applications online that are accessed from another Web service or software like a Web browser, while the software and data are stored on servers. A key element of cloud computing is the customization and the creation of a user-defined experience.

Video transcoding of multimedia files is the direct digital-to-digital conversion of one encoding to another for multimedia files. It converts a previously compressed video signal into another one with different format, such as different bit rate, frame rate, frame size, or compression standard. This is often done in cases where a target device does not support the format or has limited storage capacity that mandates reduced file size, or to convert incompatible or obsolete data to a more supported or modern format of a multimedia file. Due to the expansion and diversity of multimedia applications and present communication infrastructure comprising different underlying networks and protocols, there has been a growing need for inter-network multimedia communications over heterogeneous networks. Transcoding is a computationally expensive process with a high peak-to-trough ratio (“bursty”). The rapidly growing need in transcoding requires high scaling capability in the system.

A content delivery network or content distribution network (CDN) is a system of computers containing copies of data placed at various nodes of a network. When properly designed and implemented, a CDN can improve access to the data it caches by increasing access bandwidth and redundancy, and reducing access latency. Data content types often cached in CDNs include web objects, downloadable objects (media files, software, documents), applications, live streaming media, and database queries.

### SUMMARY OF THE INVENTION

These and other problems are generally solved or circumvented, and technical advantages are generally achieved, by embodiments of a system and method.

In accordance with an example embodiment, a method for transcoding in a cloud computing platform is provided. The method comprises receiving a first uploading file, which may be a multimedia file, by a receiver one data block at a time wherein the data block may have a size of several kilobytes, storing a plurality of received data blocks of the first uploading file, generating a first small segment file from the plurality of received data blocks while still receiving a new data block of the first uploading file, and transcoding by a transcoder the first small segment file from one format such as a bit rate or a frame size to another while the receiver is still receiving a new data block of the first uploading file. The method may further comprise generating a second small segment file from a second plurality of received data blocks while the receiver is still receiving a new data block of the first uploading file, and transcoding the second small segment file by a second transcoder.

In accordance with an example embodiment, the method further comprises receiving a request for uploading the first uploading file by a load balancer module, wherein the request is scheduled by a scheduler before starting to upload the first uploading file to the receiver.

In accordance with an example embodiment, generating the first small segment file from the plurality of received data blocks comprises comparing a size of the plurality of received data blocks of the first uploading file with a threshold and generating the first small segment file when the size of the plurality of received data blocks of the first uploading file is larger than the threshold. The generated first small segment file may be stored in an independent storage module before transcoding by the transcoder, wherein the independent storage module comprises a first storage unit to store a file and a second storage unit to store a database.

In accordance with an example embodiment, the method further comprises transcoding by the transcoder a plurality of small segment files generated by the receiver, and stitching the plurality of transcoded small segment files together to form a stitched file which is a transcoded file of the first uploading file. The method further comprises storing the stitched file in a file storage module to be downloaded through a content distribution network (CDN).

In accordance with an example embodiment, the method further comprises: receiving a second uploading file by a second receiver one data block at a time, storing a plurality of received data blocks of the second uploading file, generating a second small segment file from the plurality of received data blocks of the second uploading file while still receiving a new data block of the second uploading file, and transcoding by a second transcoder the second small segment file while the receiver is still receiving a new data block of the second uploading file.

In accordance with an example embodiment, the method further comprises receiving by a first streaming server the transcoded first small segment file for streaming over a network while the receiver is still receiving a new data block of the first uploading file. The method further comprises transcoding the first small segment file by the transcoder into an additional transcoded first small segment file, wherein the additional transcoded first small segment file has a different bit rate from the transcoded first small segment file supplied to the first streaming server, and wherein the additional transcoded first small segment file is supplied to a second streaming server for streaming over a network while the receiver is still receiving a new data block of the first uploading file.

In accordance with an example embodiment, a system for transcoding in a cloud computing platform is provided. The system comprises a receiver configured to receive a first uploading file which may be a multimedia file, one data block at a time wherein the data block may have a size of several kilobytes, a storage configured to store a plurality of received data blocks of the first uploading file, a split-while-uploading module configured to generate a first small segment file from the plurality of received data blocks while the receiver still receiving a new data block of the first uploading file, and a transcoder configured to transcode the first small segment file from one format such as a bit rate or a frame size to another while the receiver is receiving a new data block of the first uploading file. The system may comprise a second transcoder which transcodes a second small segment file generated from a second plurality of received data blocks while the receiver is still receiving a new data block of the first uploading file.

In accordance with an example embodiment, the system further comprises a load balancer module receiving a request for uploading the first uploading file, and a schedule schedules the request before starting to upload the first uploading file to the receiver.

In accordance with an example embodiment, the system further comprises an independent storage module which stores the first small segment file before it is transcoded by the transcoder, wherein the independent storage module comprises a first storage unit to store a file and a second storage unit to store a database.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1(a)-1(b) illustrate cloud computing platforms;

FIGS. 2(a)-2(c) illustrate transcoding systems in the cloud that perform split-while-uploading transcoding;

FIGS. 3(a)-3(b) illustrate transcoding systems with various independent storage modules;

FIG. 4 illustrates a transcoding system with multiple transcoders;

FIG. 5 illustrates a transcoding system with a load balancer and third party support tools;

FIG. 6 illustrates a transcoding system wherein the transcoded file is delivered to users by CDN; and

FIG. 7 illustrates a transcoding system implemented using current technology.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Cloud computing is a distributed computing service, preferable for data-intensive processing, like web-scale problems, large data centers, highly interactive web applications and others. Cloud application services or “Software as a Service (SaaS)” deliver software as a service over the Internet, eliminating the need to install and run the application on the customer's own computers and simplifying maintenance and support. Cloud platform services or “Platform as a Service (PaaS)” deliver a computing platform and/or solution stack as a service, often consuming cloud infrastructure and sustaining cloud applications. The platform facilitates deployment of applications without the cost and complexity of buying and managing the underlying hardware and software layers. Cloud infrastructure services, also known as “Infrastructure as a Service (IaaS)”, delivers computer infrastructure—typically a platform virtualization environment—as a service. Rather than purchasing servers, software, data-center space or network equipment, clients instead buy those resources as a fully outsourced service.

Web Services is a collection of remote computing services that together make up a cloud computing platform, offered over the Internet by a service provider such as Amazon.com. Web Services can be accessed over HTTP protocol, using Representational State Transfer (REST) and Simple Object Access Protocol (SOAP) protocols.

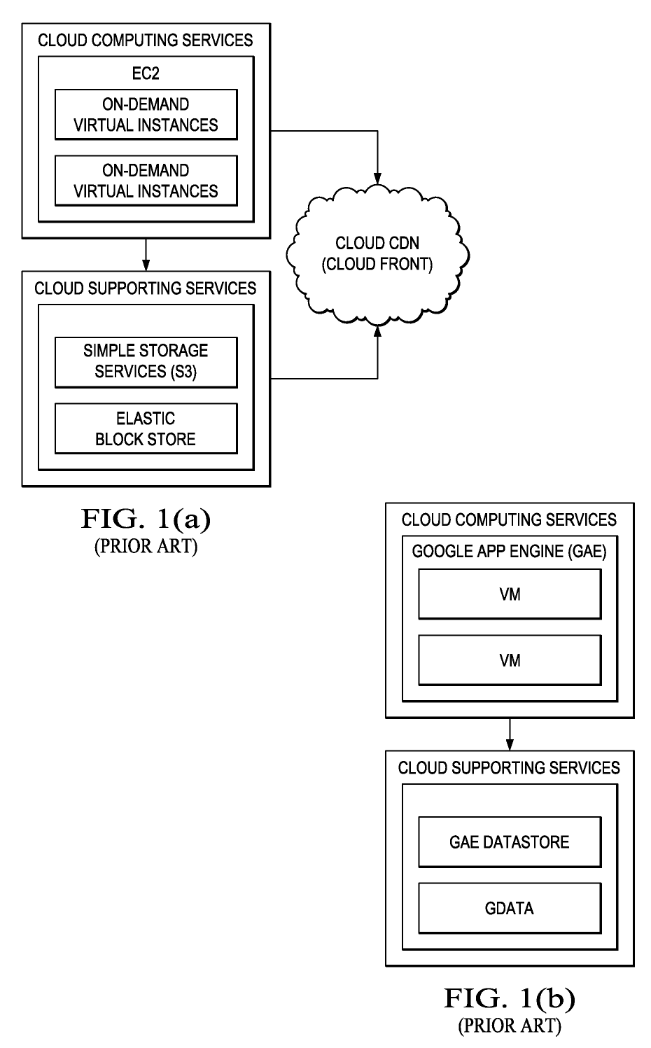

FIG. 1(a) illustrates a collection of web services provided by cloud computing service provider Amazon. Amazon Elastic Compute Cloud (Amazon EC2) is a web service that provides a base platform computing capacity in the cloud. EC2 makes it simple to create, launch, and provision virtual instances—at any time—for personal or business needs, and adjust capacity based upon demand. The virtual instances run inside the secure environment of Amazon's data centers. Amazon Simple Storage Service (S3) is a storage service. It provides a simple web services interface that can be used to store and retrieve any amount of data, at any time, from anywhere on the web. Amazon Elastic Block Store (EBS) provides block level storage volumes for use with Amazon EC2 instances. Amazon CloudFront is a web service for content delivery. It gives developers and businesses an easy way to distribute content to end users with low latency, high data transfer speeds, and no commitments. CloudFront works seamlessly with Amazon S3.

Besides Amazon, there are other cloud computing service providers. Google App Engine (often referred to as GAE or simply App Engine, and also referenced by the acronym GAE/J), illustratively shown in FIG. 1(b), is a cloud computing platform for developing and hosting web applications in Google-managed data centers. Google App Engine is a PaaS technology. It virtualizes applications across multiple servers. Google currently supports Python, Java and several languages based on Java as a programming language for the Google App Engine. Google App Engine is scalable—adding virtual machine (VM) instances as needed. Some HTTP requests may require loading a server instance before the request can be satisfied. Google refers to these as “loading requests.” GAE has supporting services such as data storage GAE datastore and Gdata serving different data needs.

The PaaS technologies, such as provided by Google and Amazon, are shown for illustrative purposes only and are not limiting. There are other service providers in the market with other forms of PaaS technologies. The embodiments disclosed in the current disclosure may work with any of the PaaS technologies.

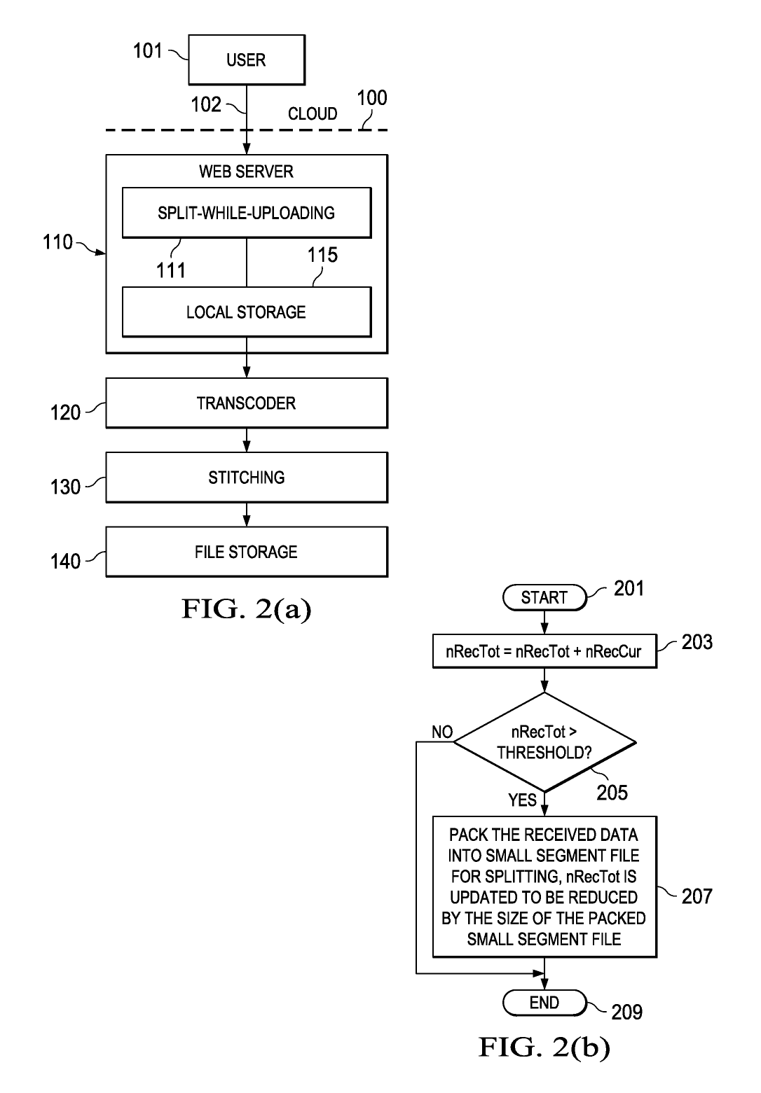

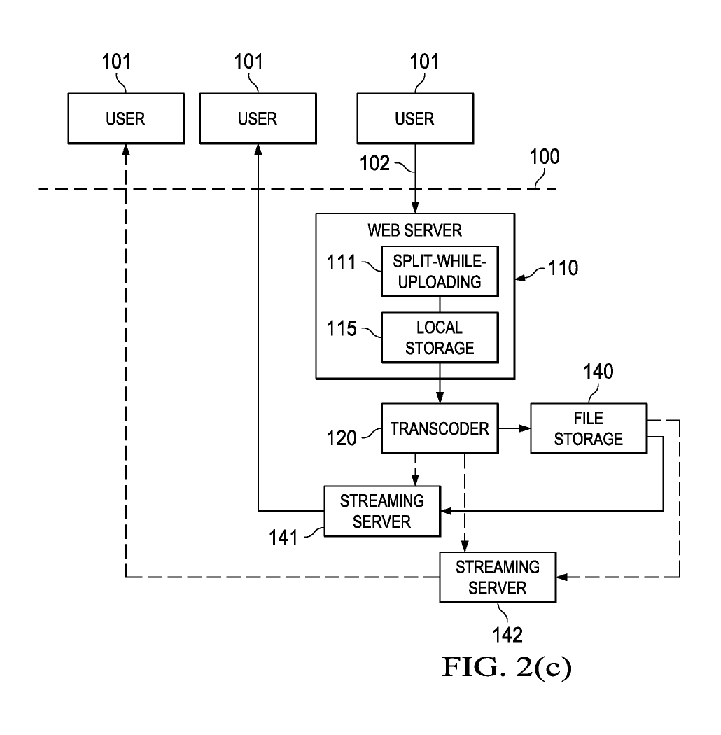

FIG. 2(a) illustrates an embodiment of split-while-uploading video transcoding of multimedia files in the cloud. As shown in FIG. 2(a), a user 101 may communicate to a web server 110 running in a cloud platform provided by a cloud computing service provider. The service provider may be Amazon, Google, or any other service provider. The line 100 separating the user 101 and the cloud is only for illustrative purposes. The web server 110 may comprise a physical hardware server in addition to related software. The web server 110 may comprise a combination of hardware and software, or solely software implemented on the cloud computing platform. In the case where the web server 110 is implemented in software, the web server 110 may be a light weight web server written in Ruby language. The web server may be implemented in other languages as well.

The user 101 may be a user operating an equipment such as a desktop computer or a laptop computer. The user may be operating other equipments such as iPhone, an IPAD, a smart phone, a music player, a multimedia player, or any other computing devices. User 101 may be communicating to the web server 110 over HTTP protocol, using Representational State Transfer (REST) and SOAP protocols. The user 101 in FIG. 1 is only for illustrative purposes and may represent a plurality of users.

The user 101 may send a request 102 for multimedia file uploading to the web server 110. The request 102 is only for illustrative purposes and is not limiting. There may be a plurality of requests. The multimedia file may be a video file, an audio file such as a MP3 file, or a picture file such as a JPEG file. The multimedia file may be just a text file. The terms multimedia file and file are used as general terms to refer any possible file format and content. The web server 110 receives the request from user 102 and determines whether to grant the request based on certain criteria such as the load of the server, the storage in the cloud, and so on. After the request is granted by the web server 110 or other related function unit or virtual instance running in the cloud, the user 101 starts to upload file data.

The web server 110 may comprise a split-while-loading module 111 and a local storage module 115 to store temporary files. The split-while-uploading module 111 performs operations outlined in FIG. 2(b). The module 111 within the web server 110 periodically checks if the size of the received portion of a file exceeds the predefined threshold. If the threshold is reached, the received portion of the file will be packed into a small segment file, which will be passed to a transcoder module 120 to perform transcoding of the small segment file, while the web server 110 is receiving the next round of data until the data size reaches the size of the uploading file.

The operation of the split-while-uploading module 111 is illustrated in FIG. 2(b). After the request for uploading is granted, the user 101 sends the file data block by block, one block at a time. Each data block may be of several kilobytes in size, or other sizes such as several megabytes. In some embodiments, each data block may be of the same size. In some other embodiments, data blocks may have different sizes. The received data blocks may be saved in the local storage module 115. From time to time, while the web server 110 receives the data block, the splitting-while-uploading module 111 is called to check whether the total size of the currently accumulated received data blocks which have not been packed into small segment files is larger than a preset threshold value. If the size of the currently accumulated received data blocks which have not been packed into small segment files is bigger than the present threshold value, the currently accumulated received data blocks will be packed into a small segment file which will be sent to the transcoder 120. Otherwise the splitting-while-uploading module 111 will wait and the web server will keep on receiving a plurality of data blocks. In FIG. 2(b), the variable nRecTot is the total received data block size before the currently receiving data block, nRecCur is the current received data block size, and THRESHOLD is the preset threshold value. The module 111 starts at step 201, and checks to see whether nRecTot is bigger than the threshold value in step 205. If the answer is No, the module 111 does nothing and ends at step 209. If the answer is Yes, the module 111 moves to step 207 to pack the received data blocks into a small segment file, thus splitting the uploading file into a group of small segment files. The step 207 further reduces the nRecTot by the size of the packed small segment file. The small segment files may be first stored in a local storage module 115, waiting to be transcoded by the transcoder module 120.

The small segment file generated by the web server 110 may be passed to the transcoder module 120 automatically by the web server 110, or it may be passed to the transcoder module 120 when requested by the transcoder 120. The transcoder 120 may perform transcoding on the small segment file to convert one type of encoding to another. It may convert a previously compressed file into another one with different format. If the file is a video file, the transcoder may convert it to a different bit rate, frame rate, frame size, or compression standard.

If an uploading file is split into a plurality of small segment files for transcoding, a stitching module 130 performs a final stitching operation on each individually transcoded small segment file. After the transcoded small segment files are stitched together in module 130 to form a final stitched file, the stitched file is placed in a file storage module 140. The stitched file should be the same as a transcoded version of the user uploaded file had the user uploaded the complete file first and then the complete file was transcoded after it finished uploading.

In the embodiment illustrated in FIG. 2(a), the transcoding and the uploading of an uploading file are done in parallel. The transcoder 120 is performing file transcoding while the web server 110 is receiving uploading file data blocks at the same time. Therefore the total time for uploading and transcoding is reduced. All the function modules such as web server 110, transcoder 120, stitching module 130, may be implemented as a virtual machine or virtual instance in the cloud provided by the service provider. The stored file in the file storage module 140 may be downloaded by other users. The downloading may be at a later time after the file is uploaded and stitched together.

In some other illustrative embodiments, a transcoded small segment file generated by the transcoder module 120 may be directly passed to a streaming server 141 in real time for smooth streaming of multimedia files, as shown in FIG. 2(c). For those embodiments, generally there is no need to perform the final stitching of the small segment files that are individually transcoded. The small transcoded file may pass through the file storage module 140 then pass to the smooth streaming server 141. The small transcoded file may pass directly from the transcoder 120 to the streaming server 141, for delivery to the users. Furthermore, there may be a plurality of streaming servers 141 and 142 that receive transcoded small segment files from the transcoder 120. For smooth streaming purposes, a video file may be transcoded into a different resolution video format such as the x264 format. The file may be transcoded into other formats as well, such as Silverlight, Flash, and IPhone player enabled video formats respectively. While transcoded to the smooth streaming video format, different bit rates may be generated concurrently to the different streaming server 141, 142, and so on.

Many other illustrative embodiments may be demonstrated with various different configurations, such as different storage modules, multiple transcoders, load balancing with a scheduler to handle multiple requests from multiple users, and a CDN to deliver the uploaded files to multiple users, with or without third party tools. Many of those configurations work for streaming servers shown in FIG. 2(c), or for upload file to storage as shown in FIG. 2(a). For illustration purposes, only upload file to storage embodiments are demonstrated in the following embodiments. One skilled in the art can easily adopt the configurations to streaming servers as well.

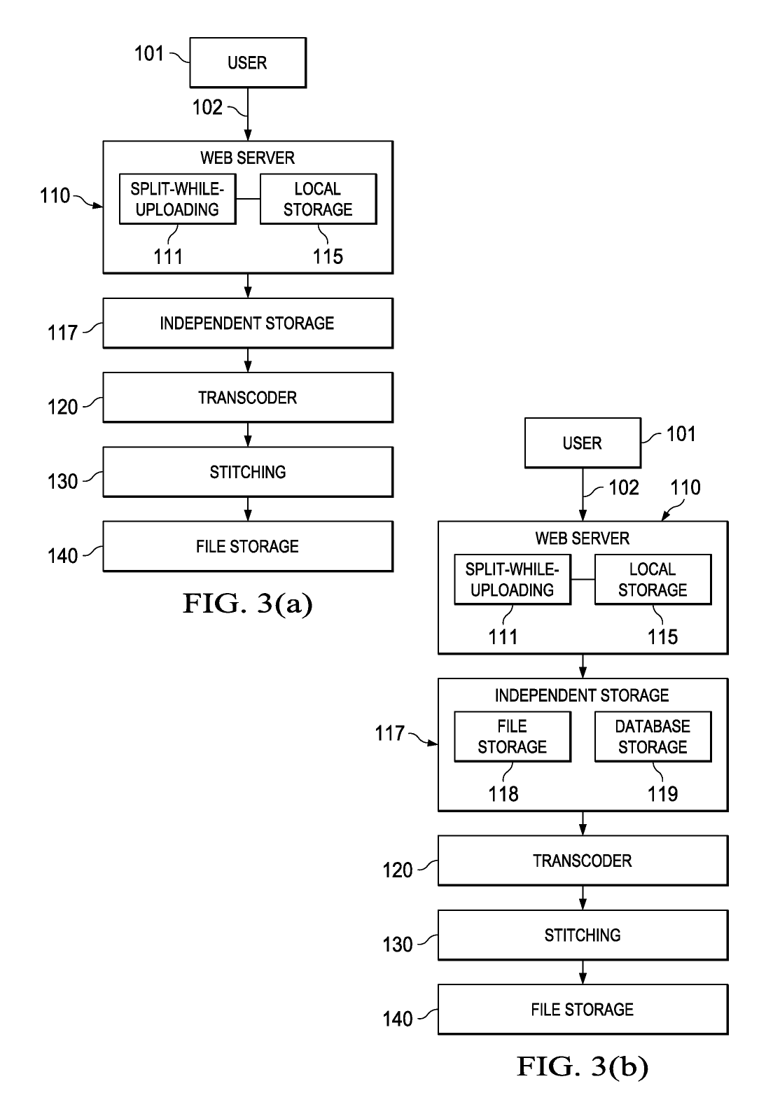

In FIG. 3(a), an independent storage module 117 is added in the system configuration in the cloud. The independent storage module 117 is outside the web server 110, therefore the creation of the module 117, and its management may be done differently from the web server 110. Once the uploaded file has been uploaded to the web server 110, and a small segment file has been generated, the web server 110 passes the generated small segment file to the independent storage module 117 for persistent storage. On the other end, the transcoder module 120 may communicate with the independent storage module 117 to periodically or randomly check for new uploaded small segment files. If there are such small segment files stored in the independent storage module 117, the transcoder module 117 may receive the small segment files and transcode those files accordingly. The independent storage unit 117 may be used when the speed for the user uploading file is faster than the speed the transcoder performs transcoding so that the capacity of the temporary storage module 115 inside the web server 110 is not enough to store the segmented files. It is an option to store uploaded files in the independent storage module 117 even when there is enough space in the local storage 115 to store files.

In FIG. 3(b), the independent storage module 117 is further divided into two kinds of storage. In FIG. 3(b), the module 118 is for file storage and the module 119 is for database storage. Such illustrations are for demonstration only, and are not limiting. There may be other kinds of storage classifications as well. As illustrated in FIG. 3(b), once a small segment file has been generated and passed to the independent storage unit 117, the small segment file may be stored in the file storage module 118 and a record of the small segment file is created in the database storage module 119. The database storage module may run a MySQL database or an Oracle database, or any other available database. At the other end, the transcoder 120 may check the database for newly generated small segment files for transcoding. In another embodiment, the transcoder 120 may check the file storage for newly generated small segment files for transcoding. Sometimes the checking of the database record for small segment files may be advantageous because the size of the database may be smaller and therefore the searching of a new record may be faster.

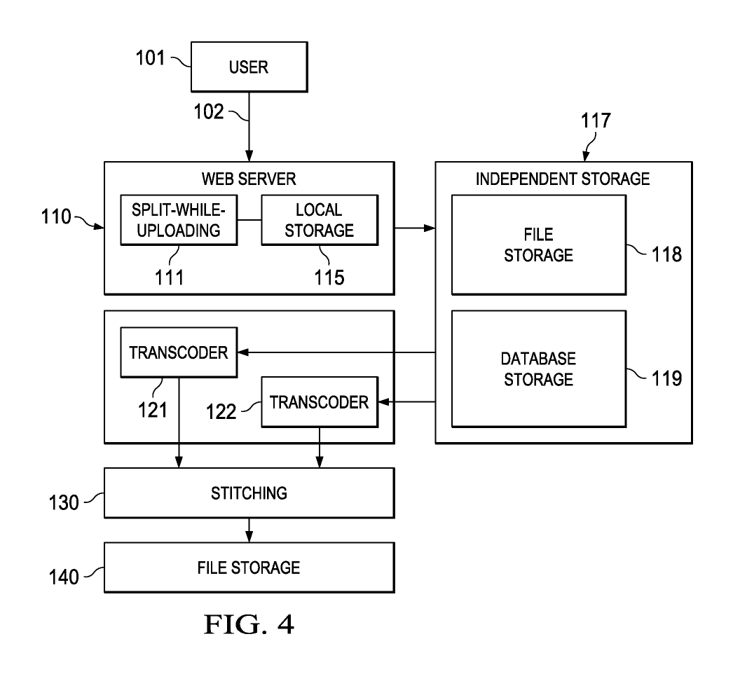

FIG. 4 illustrates an embodiment comprising multiple transcoders 121 and 122. Such an embodiment may be advantageous when there are multiple users or a user has multiple uploading files that there are generating many small segment files in the storage. The number of transcoders 121 and 122 is only for illustration purposes and is not limiting. That is, there may be more than two transcoders. For example, there may be thousands or millions of transcoders depending on the specific application. Each transcoder may perform independent transcoding of small segment files passed from the storage module such as independent storage module 117. The small segment files may be passed to the transcoder modules randomly, or with a first come first serve scheduling principle wherein the scheduling may be done by the independent storage module. The transcoder may check the independent storage module 117 periodically or aperiodically for newly generated small segment files to be transcoded. All the finished transcoded small segment files by each transcoder may be passed to the stitching module 130 for final assembly.

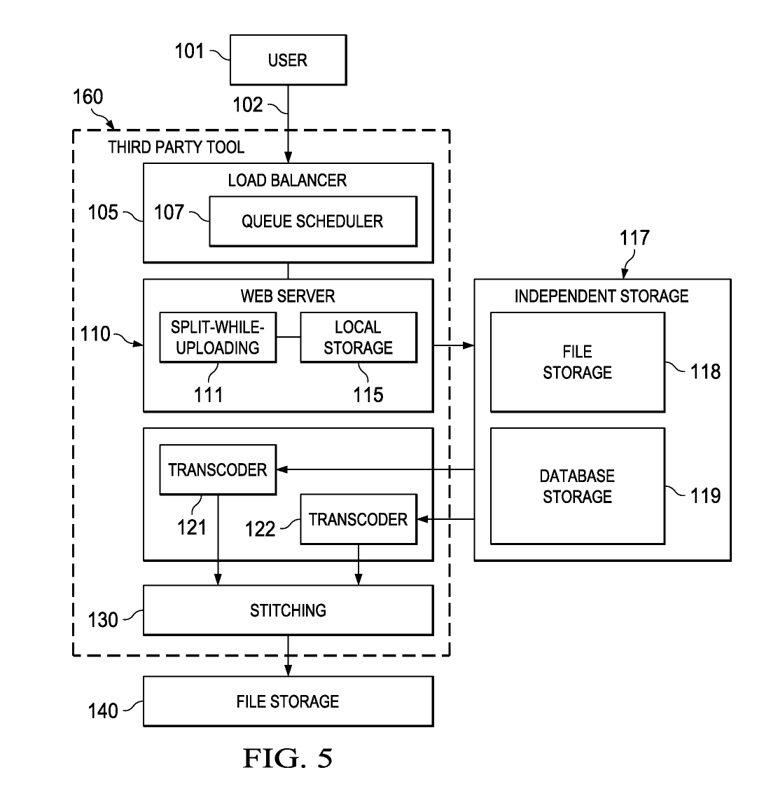

FIG. 5 illustrates an embodiment comprising a load balancer 105 having a queue scheduler 107. Such an embodiment may be advantageous when there are multiple users or a user has multiple uploading files. Requests 102 from the users 101 are queued in the queue, and the queue scheduler 107 is used to schedule the requests. The queue may be a FIFO job queue or other kinds of more advanced queues, such as priority based queues, user budget model or emergency/fault handling queues. The uploading request 102 from a user 101 is first granted access and then scheduled by the load balancer module 105 to start uploading to the web server. The scheduler may implement a round-robin algorithm or any other kind of scheduling algorithm to schedule a request to start uploading. The user will then start to upload files to the web server 110, which may split the files and save them to the independent storage module 117, waiting to be transcoded by a transcoder 120.

It is noted that the load balancer module 105, the independent storage module 117 and its configuration, the multiple transcoder modules 121 and 122 generally are all configured independent from each other. For example, an embodiment may comprise a load balancer but without an independent storage module; while another embodiment may comprise an independent storage module and multiple transcoders, but without a load balancer. One of ordinary skill in the art will readily appreciate that there may be many variations of the disclosed embodiments.

It is further noted that the various independent modules such as the load balancer module 105, the web server 110, the multiple transcoder 121 and 122, and the stitching module 130 may be implemented by a third party provider rather than the cloud computing service provider. Those independent modules may be provided together by a third party software provider as a unit, or by a single or multiple third party providers as independent units. FIG. 5 illustrates an embodiment where the load balancer module 105, the web server 110, the multiple transcoder 121 and 122, and the stitching module 130 may be provided as one single third party tool unit 160. The single unit 160 is only for illustration purposes and is not limiting.

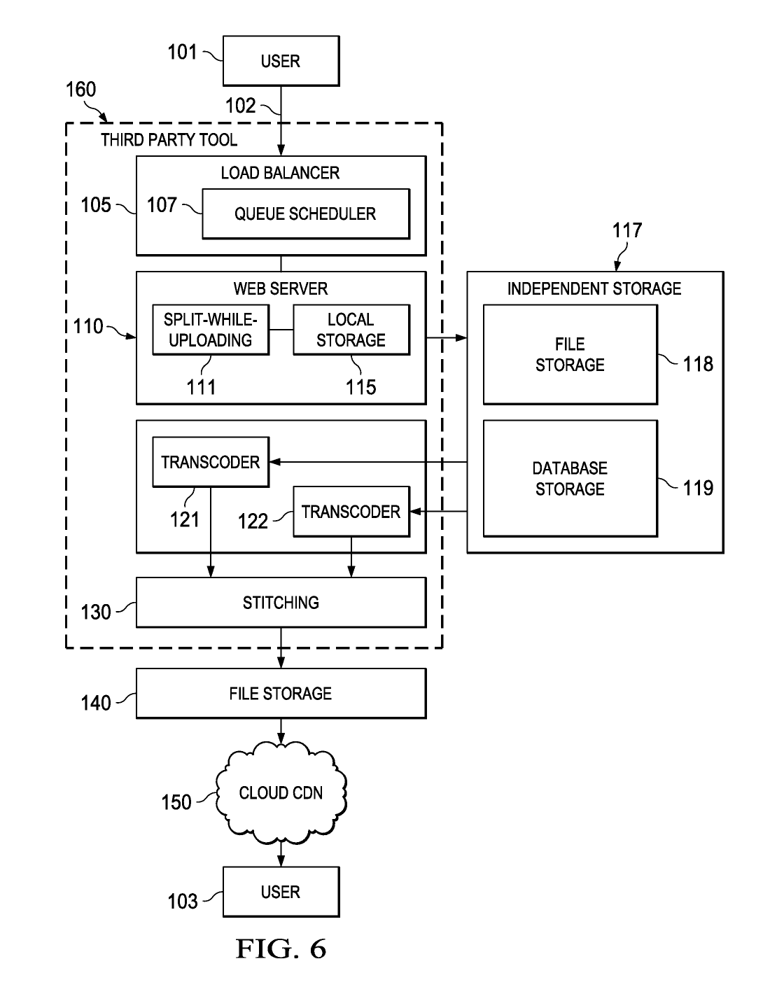

FIG. 6 further illustrates an embodiment wherein the transcoded files stored in the file storage module 140 may be delivered to various users through a CDN 150 for fast downloading of the transcoded results. The CDN 150 may be the CloudFront service in Amazon Cloud service for fast file distribution. The CDN 150 may be other services provided by other service providers. The CDN distributions may be performed using the HTTP or HTTPS protocols, or streamed using the RTMP protocol.

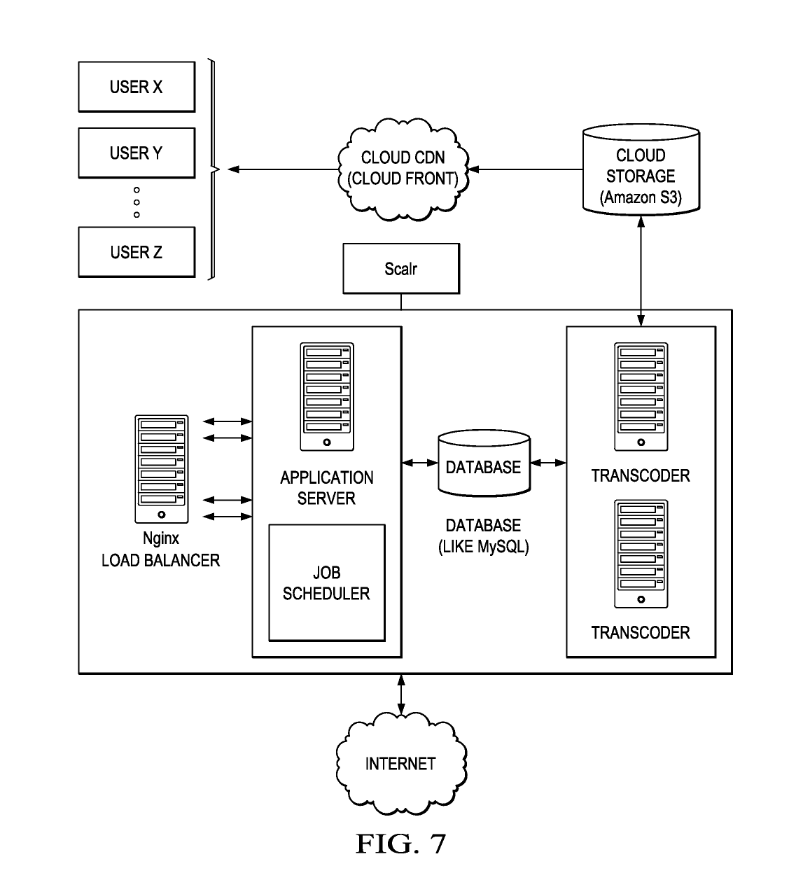

As a further illustration, FIG. 7 demonstrates a system implemented according to an embodiment. In FIG. 7, the transcoder module may be a cloud-based transcoding service provided by companies such as Pandastream, HDCloud, Encoding.com, Netflix, and Ankoder etc. The load balancer module may be provided by service such as Nginx, which can perform a light-weight connection load balancing role. The application server may be a PandaStream server which is an open source of a transcoding platform running upon Amazon Web Services. The Pandastream server runs completely within Amazon's Web Services utilizing EC2 and S3. Scalr is an open source web based cloud computing platform for managing Amazon EC2 platforms. With Scalr, the web application can grow to millions of users with little effort. Scalr will provision on-the-fly new servers to handle spikes in demand, and decommission them when no longer needed to reach the lower cost.

Although the present embodiments and their advantages have been described in detail, it should be understood that various changes, substitutions and alterations can be made herein without departing from the spirit and scope of the embodiments as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for transcoding in a cloud computing platform, the method comprising:
receiving a first uploading file by a receiver one data block at a time;
storing a plurality of received data blocks of the first uploading file;
generating a first small segment file from the plurality of received data blocks while still receiving a new data block of the first uploading file; and
transcoding by a transcoder the first small segment file while the receiver is still receiving a new data block of the first uploading file.

2. The method of claim 1, further comprising:
transcoding by the transcoder a plurality of small segment files generated by the receiver; and
stitching the plurality of transcoded small segment files together to form a stitched file which is a transcoded file of the first uploading file.

3. The method of claim 2, further comprising:
storing the stitched file in a file storage module to be downloaded through a content distribution network (CDN).

4. The method of claim 1, further comprising:
receiving by a first streaming server the transcoded first small segment file for streaming over a network while the receiver is still receiving a new data block of the first uploading file.

5. The method of claim 4, further comprising:
transcoding the first small segment file by the transcoder into an additional transcoded first small segment file, wherein the additional transcoded first small segment file has a different bit rate from the transcoded first small segment file supplied to the first streaming server, and wherein the additional transcoded first small segment file is supplied to a second streaming server for streaming over a network while the receiver is still receiving a new data block of the first uploading file.

6. The method of claim 1, wherein the generating the first small segment file comprises comparing a size of the plurality of received data blocks of the first uploading file with a threshold and generating the first small segment file when the size of the plurality of received data blocks of the first uploading file is larger than the threshold.

7. The method of claim 1, wherein the first uploading file is a multimedia file.

8. The method of claim 1, wherein the transcoder transcodes the first small segment file from a format of the first uploading file to a second format for the transcoded first small segment file.

9. The method of claim 1, wherein the transcoder transcodes the first small segment file from a bit rate or a frame size of the first uploading file to a second bit rate or a second frame size for the transcoded first small segment file.

10. The method of claim 1, wherein a data block has a size of several kilobytes.

11. The method of claim 1, further comprising:
generating a second small segment file from a second plurality of received data blocks while still receiving a new data block of the first uploading file; and
transcoding the second small segment file by a second transcoder.

12. The method of claim 1, further comprising:
storing the generated first small segment file in an independent storage module before transcoding by the transcoder.

13. The method of claim 12, wherein the independent storage module comprises a first storage unit to store a file and a second storage unit to store a database.

14. The method of claim 1, further comprising:
receiving a request for uploading the first uploading file by a load balancer module, wherein the request is scheduled by a scheduler before starting to upload the first uploading file to the receiver.

15. The method of claim 1, further comprising:
receiving a second uploading file by a second receiver one data block at a time;
storing a plurality of received data blocks of the second uploading file;
generating a second small segment file from the plurality of received data blocks of the second uploading file while still receiving a new data block of the second uploading file; and
transcoding by a second transcoder the second small segment file while the receiver is still receiving a new data block of the second uploading file.

16. A system of cloud computing, comprising:
a receiver configured to receive a first uploading file one data block at a time;
a storage configured to store a plurality of received data blocks of the first uploading file;
a split-while-uploading module configured to generate a first small segment file from the plurality of received data blocks while the receiver still receiving a new data block of the first uploading file; and
a transcoder configured to transcode the first small segment file while the receiver is receiving a new data block of the first uploading file.

17. The system of claim 16, further comprising:
an independent storage module configured to store the first small segment file before it is transcoded by the transcoder.

18. The system of claim 17, wherein the independent storage module comprises a first storage unit to store a file and a second storage unit to store a database.

19. The system of claim 16, further comprising:
a load balancer module configured to receive a request for uploading a first uploading file; and
a scheduler configured to schedule the request before starting to upload the first uploading file to the receiver.

20. The system of claim 16, further comprising:
a second transcoder configured to transcode a second small segment file generated from a second plurality of received data blocks of the first uploading file while the receiver is receiving a new data block of the first uploading file.
